(19) United States
(12) Patent Application Publication
(10) Pub. No.: US 2022/0398633 A1
(43) Pub. Date: Dec. 15, 2022

(54) LEAD DATA PROCESSOR FOR ENABLING AI-DRIVEN INTERACTIONS WITH CONSUMERS

(71) Applicant: Aktify, Inc., Lehi, UT (US)

(72) Inventors: Joe Hawkins, Bluffdale, UT (US); Amir Ali Abdullah, Provo, UT (US); Arman Riahi, Los Gatos, CA (US); Russell S. Maxfield, Herriman, UT (US); Kreg Peeler, Draper, UT (US)

(21) Appl. No.: 17/346,055

(22) Filed: Jun. 11, 2021

(51) Int. Cl. G06Q 30/02; G06N 5/04

(52) U.S. Cl. CPC G06Q 30/0271; G06Q 30/0201; G06N 5/04

(57) ABSTRACT

A lead data processor can enable AI-driven interactions with consumers. The lead data processor can be configured to efficiently extract and accurately predict information for consumers using raw lead data that businesses provide. As a result, a lead management system can more effectively rely on artificial intelligence to convert the raw lead data into appointments between businesses and consumers.

### CROSS-REFERENCE TO RELATED APPLICATIONS

N/A

### BACKGROUND

A lead can be considered a contact, such as an individual or an organization, that has expressed interest in a product or service that a business offers. A lead could merely be contact information such as an email address or phone number, but may also include an individual's name, address or other personal/organization information, an identification of how an individual expressed interest (e.g., providing contact/personal information via a web-based form, signing up to receive periodic emails, calling a sales number, attending an event, etc.), communications the business may have had with the individual, etc. A business may generate leads itself (e.g., as it interacts with potential customers) or may obtain leads from other sources.

A business may use leads as part of a marketing or sales campaign to create new business. For example, sales representatives may use leads to contact individuals to see if the individuals are interested in purchasing any product or service that the business offers. These sales representatives may consider whatever information a lead includes to develop a strategy that may convince the individual to purchase the business's products or services. When such efforts are unproductive, a lead may be considered dead. Businesses typically accumulate a large number of dead leads over time.

Recently, efforts have been made to employ artificial intelligence to identify leads that are most likely to produce successful results. For example, some solutions may consider the information contained in leads to identify which leads exhibit characteristics of the ideal candidate for purchasing a business's products or services. In other words, such solutions would inform sales representatives which leads to prioritize, and then the sales representatives would use their own strategies to attempt to communicate with the respective individuals.

### BRIEF SUMMARY

The present invention extends to a lead data processor for enabling AI-driven interactions with consumers and to systems, methods and computer program products for processing lead data to enable AI-driven interactions with consumers. A lead management system can include a lead data processor that is configured to efficiently extract and accurately predict information for consumers using raw lead data that businesses provide. As a result, a lead management system can more effectively rely on artificial intelligence to convert the raw lead data into appointments between businesses and consumers.

In some embodiments, the present invention may be implemented as a method for processing raw lead data to enable AI-driven interactions with consumers. Raw lead data that represents a plurality of leads can be received. For each of the plurality of leads represented in the raw lead data, a lead processing result object can be generated. Each lead processing result object defines a plurality of fields, one or more predicted results for each of the plurality of fields and a confidence value for each predicted result.

In some embodiments, the present invention may be implemented as computer storage media storing computer executable instructions which when executed implement a method for processing raw lead data to enable AI-driven interactions with consumers. Raw lead data that represents a plurality of leads may be received. For each of the plurality of leads represented in the raw lead data, a lead processing result object can be generated. Each lead processing result object can define: a name field, a predicted result for the name field and a confidence value for the predicted result for the name field; a phone number field, a predicted result for the phone number field and a confidence value for the predicted result for the phone number field; and a time zone field, one or more predicted results for the time zone field and a confidence value for each of the one or more predicted results for the time zone field.

In some embodiments, the present invention may be implemented as a lead management system that includes one or more processors and computer storage media storing a lead data processor that is configured to process raw lead data to enable the lead management system to have AI-driven interactions with consumers. The lead data processor may be configured to receive raw lead data that represents a plurality of leads. For each of the plurality of leads represented in the raw lead data, the lead data processor may generate a lead processing result object where each lead processing result object defines a plurality of fields, one or more predicted results for each of the plurality of fields and a confidence value for each predicted result.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example computing environment in which one or more embodiments of the present invention may be implemented;

FIG. 2 provides an example of various components that a lead management system may include in accordance with one or more embodiments of the present invention;

FIG. 3 provides an example of raw lead data that may be provided to a lead management system and a mapping object that may be used to process the raw lead data in one or more embodiments of the present invention;

FIG. 4 provides an example of how a lead data processor may be configured in one or more embodiments of the present invention;

FIGS. 5A-5C provide an example of how the lead data processor may process raw lead data to generate lead processing result objects for each lead in the raw lead data;

FIGS. 6A-6C provide examples of how various field processors of the lead data processor may generate processing results defining predicted results and associated confidence values; and

FIG. 7 provides an example of how confidence weights can be used to select a single predicted result from multiple predicted results.

### DETAILED DESCRIPTION

In the specification and the claims, the term “consumer” should be construed as an individual. A consumer may or may not be associated with an organization. The term “lead” should be construed as information about, or that is associated with, a particular consumer. The term “consumer computing device” can represent any computing device that a consumer may use and by which a lead management system may communicate with the consumer. In a typical example, a consumer computing device may be a consumer's phone.

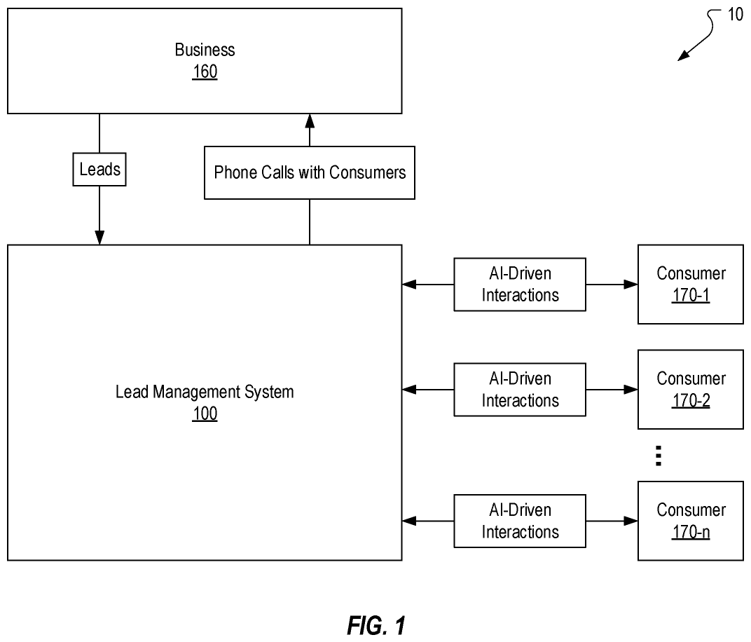

FIG. 1 provides an example of a computing environment 10 in which embodiments of the present invention may be implemented. Computing environment 10 may include a lead management system 100, a business 160 and consumers 170-1 through 170-n (or consumer(s) 170). As shown, business 160 can provide leads, in the form of raw lead data, to lead management system 100 where the leads can correspond with consumers 170. Typically, these leads may be dead leads that business 160 has accumulated, but any type of lead may be provided in embodiments of the present invention. Although only a single business 160 is shown, there may typically be many businesses 160.

Lead management system 100 can perform a variety of functionality on the leads to enable lead management system 100 to have AI-driven interactions with consumers 170. For example, these AI-driven interactions can be text messages that are intended to convince consumers 170 to have a phone call with a sales representative of business 160. Once the AI-driven interactions with a particular consumer 170 are successful (e.g., when the particular consumer 170 agrees to a phone call with business 160), lead management system 100 may initiate/connect a phone call between the particular consumer 170 and a sales representative of business 160. Accordingly, by only providing its leads, including its dead leads, to lead management system 100, business 160 can obtain phone calls with consumers 170.

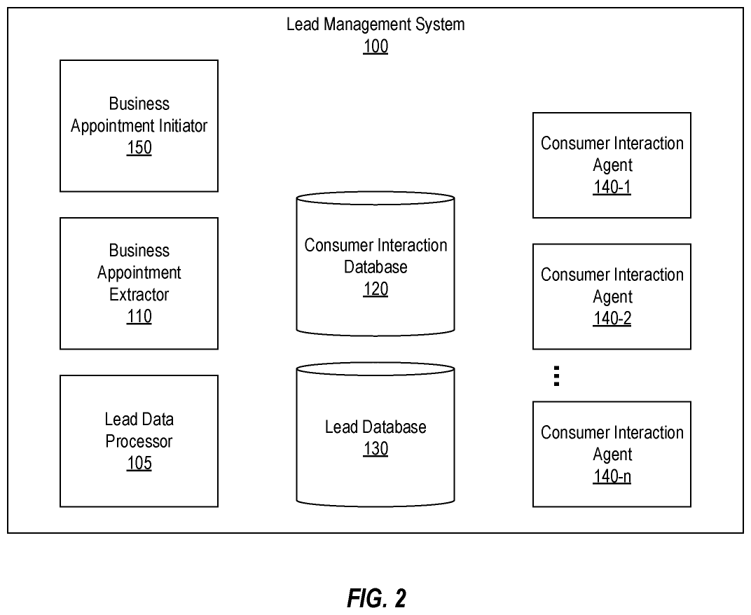

FIG. 2 provides an example of various components that lead management system 100 may include in one or more embodiments of the present invention. These components may include a lead data processor 105, a business appointment extractor 110, a consumer interaction database 120, a lead database 130, consumer interaction agents 140-1 through 140-n (or consumer interaction agent(s) 140) and a business appointment initiator 150.

Lead data processor 105 can represent one or more components of lead management system 100 that process the leads received from business 160 (e.g., the raw lead data received from business 160) to generate lead processing result objects. These lead processing result objects may be stored in lead database 130. As described in detail below, these lead processing result objects are configured to facilitate and maximize the efficiency and accuracy of AI-driven interactions that lead management system 100 may have with the corresponding consumers.

Business appointment extractor 110 can represent one or more components of lead management system 100 that implement a scheduling language and model for extracting appointments from consumer interactions. Consumer interaction database 120 can represent one or more data storage mechanisms for storing consumer interactions or data structures defining consumer interactions.

Consumer interaction agents 140 can be configured to interact with consumers 170 via consumer computing devices. For example, consumer interaction agents 140 can communicate with consumers 170 via text messages, emails or another text-based mechanism. These interactions, such as text messages, can be stored in consumer interaction database 120 and associated with the respective consumer 170 (e.g., via associations with the corresponding lead defined in lead database 130). Consumer interaction agents 140 can employ the lead processing result objects to dynamically determine the timing and content of these interactions.

Business appointment initiator 150 can represent one or more components of lead management system 100 that are configured to initiate an appointment (e.g., a phone call or similar communication) between a consumer 170 and a representative of business 160. For example, business appointment initiator 150 could establish a call with a consumer and then connect the business representative to the call. In some embodiments, business appointment extractor 110 can intelligently select the timing of such appointments by applying a scheduling language and model to the consumer interactions that consumer interaction agents 140 have with consumers 170 as is described in U.S. patent application Ser. No. 17/346,032 (Attorney Docket No. 32791.5), which is incorporated by reference.

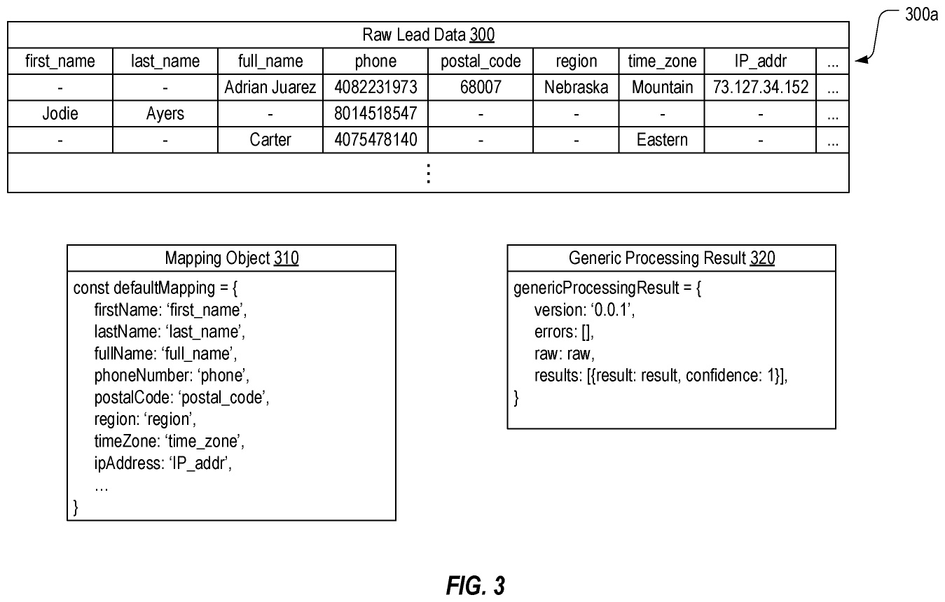

FIG. 3 provides examples of various data structures that may be used in one or more embodiments of the present invention including raw lead data 300, a mapping object 310 and a generic processing result 320. Raw lead data 300 can represent the leads that business 160 provides to lead management system 110. As an example, raw lead data 300 may be in the form of one or more comma-separated values (CSV) files. However, any structured data format could be used. A lead in raw lead data 300 can consist of values for a plurality of fields. For example, these fields could include: a first name of the consumer, a last name of the consumer, a full name of the consumer, a phone number for the consumer, a postal code for the consumer, a region of the consumer, a time zone for the consumer, an IP address of the consumer, a locality of the consumer, a source of the lead, a deliverable or offering associated with the lead, a timestamp when the lead was created, an identifier of the lead, etc. Notably, raw lead data 300 that each business 160 may provide would likely include varying sets of fields and names for such fields. Also, the raw lead data for each lead may include varying sets of values. In other words, a business may not have obtained values for all the fields defined in raw lead data 300 for each lead. In short, raw lead data 300 will likely be inconsistent and incomplete thereby making raw lead data 300 insufficient and/or ineffective for enabling consumer interaction agents 140 to have AI-driven interactions with consumers 170.

Mapping object 310 can define mappings between field names used in raw lead data 300 and standard field names used by lead data processor 105. Accordingly, a mapping object 310 could be created for each set of raw lead data 300 that lead data processor 105 may receive. In the depicted example, it is assumed that the standard field names include firstName, lastName, fullName, phoneNumber, postalCode, region, timeZone, ipAddress, etc., and that the field names (or column headings) 300a in raw lead data 300 are mapped to these standard field names.

Generic processing result 320 represents a schema that lead data processor 105 can employ to create field processing results from raw lead data 300. As an example, a field processing result can define a version, any errors, the raw data on which the field processing result is based and one or more predicted results each of which can be associated with a confidence value. The version field can be used to define the number of times a field processing result has been updated (e.g., as a result of refining a predicted result). The errors field can be used to track any errors that may have occurred when processing the respective raw lead data. In some cases a field processing result may include more than one predicted result. In such cases, the predicted result may also be associated with a method by which the result was predicted.

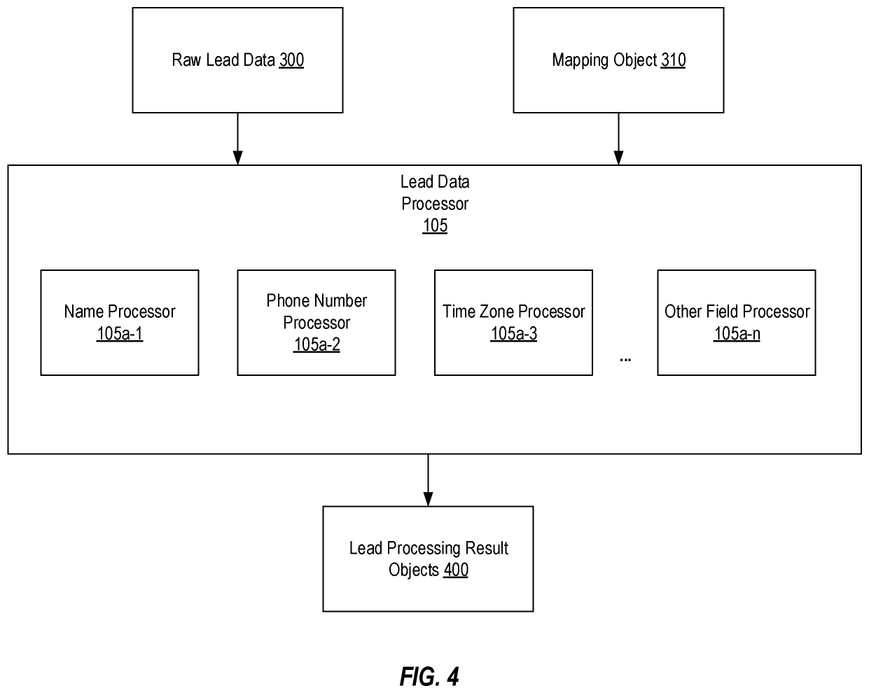

FIG. 4 provides an overview of how lead data processor 105 can process raw lead data 300. Lead data processor 105 can receive raw lead data 300 as input and may apply mapping object 310 to standardize its fields. Lead data processor 105 may include a number of field processors 105a-1 through 105a-n (collectively, field processors 105a) which are generally configured to process raw lead data 300 to generate field processing results from which lead processing result objects 400 can be generated. As described below, field processors 105a can employ natural language processing, machine learning or other artificial intelligence techniques on the data available in raw lead data 300 to generate field processing results that are most likely to be accurate for the leads.

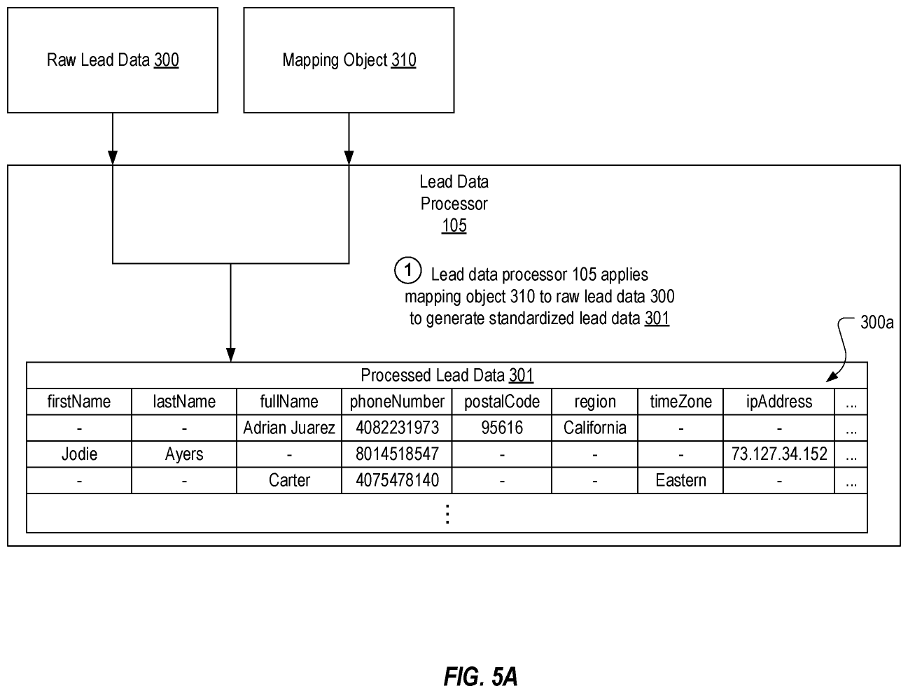

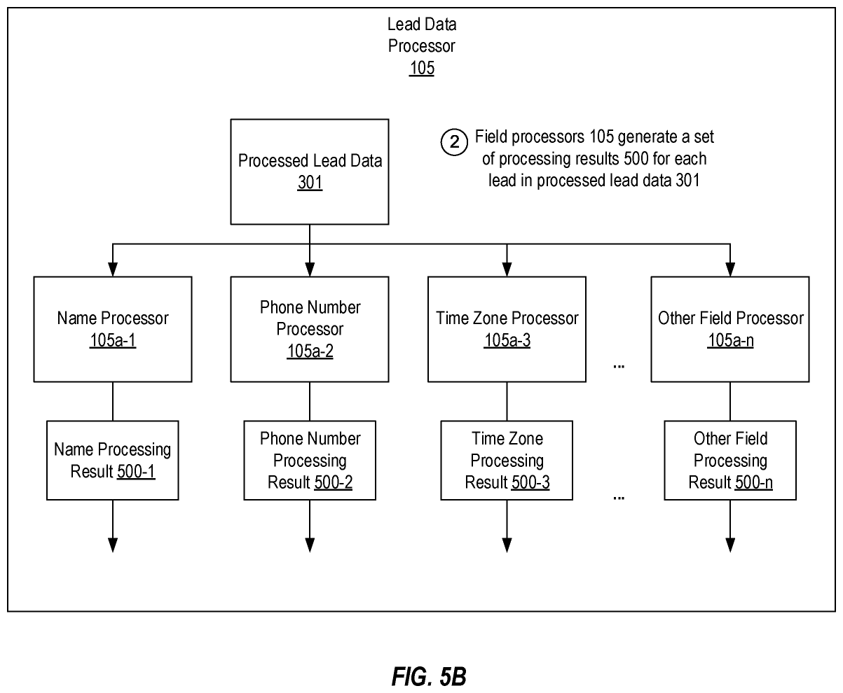

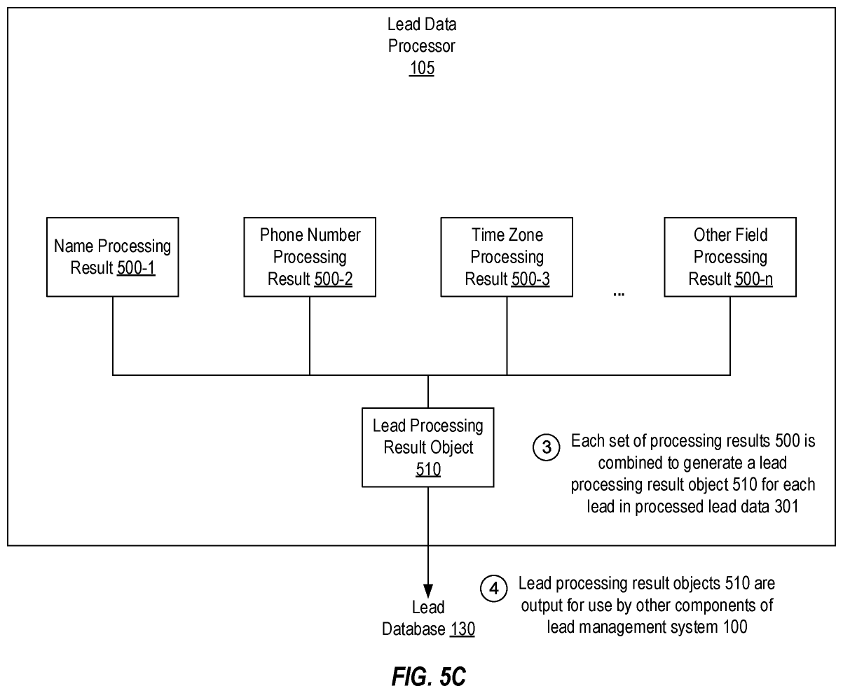

FIGS. 5A-5C provide an example of how lead data processor 105 may process a lead in raw lead data 300 in one or more embodiments of the present invention to generate a lead processing result object 510 for the lead. Lead data processor 105 could perform similar processing for each lead in raw lead data 300 such that a lead processing result object 510 will be generated for each lead.

Step 1, which is shown in FIG. 5A, represents initial processing that lead data processor 105 can perform on raw lead data 300. In particular, lead data processor 105 can apply mapping object 310 to raw lead data 300 to standardize the field names in raw lead data 300. As a result of step 1, standardized lead data 301 will be generated in which the field names 300a match the standard field names defined in mapping object 310.

Turning to FIG. 5B, in step 2, standardized lead data 301 (or at least relevant portions of standardized lead data 301) can be provided to each of field processors 105a which in turn generate respective field processing results 500-1 through 500-n (collectively field processing results 500). As described below, each field processing result can define one or more predicted results for the respective field and a confidence value for the predicted result.

Turning to FIG. 5C, in step 3, lead data processor 105 can combine each set of processing results 500 to generate a lead processing result object 510 for each lead defined in standardized lead data 301. Accordingly, a lead processing result object 510 can define the predicted result(s) for each field and the confidence value for each of the predicted results. In step 4, lead data processor 105 may output lead processing results objects 510 for use by other components of lead management system 100. For example, lead processing result objects 510 can be stored in lead database 130 where they would be accessible to consumer interaction agents 140 for use in initiating interactions with consumers 170.

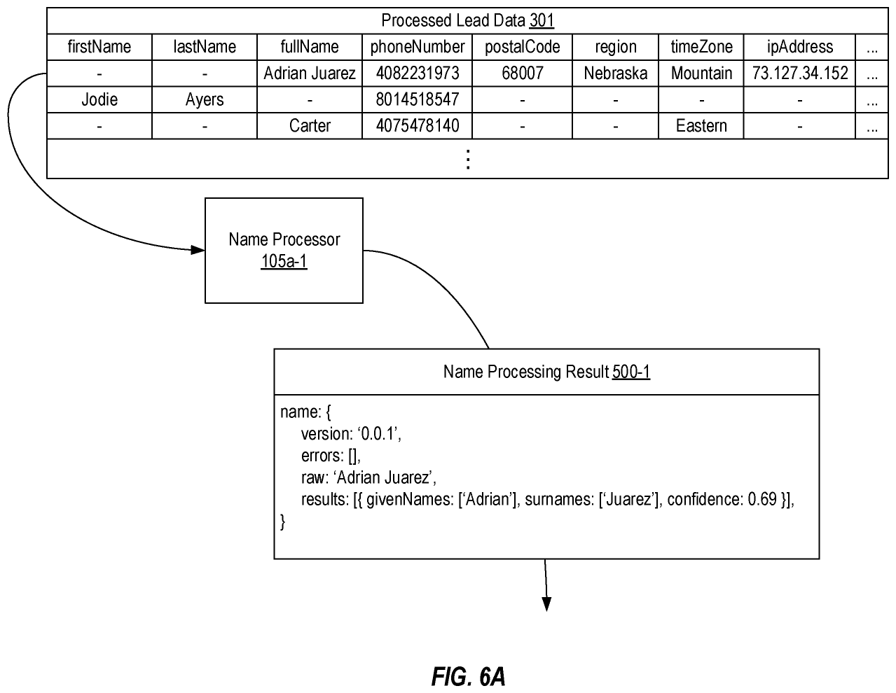

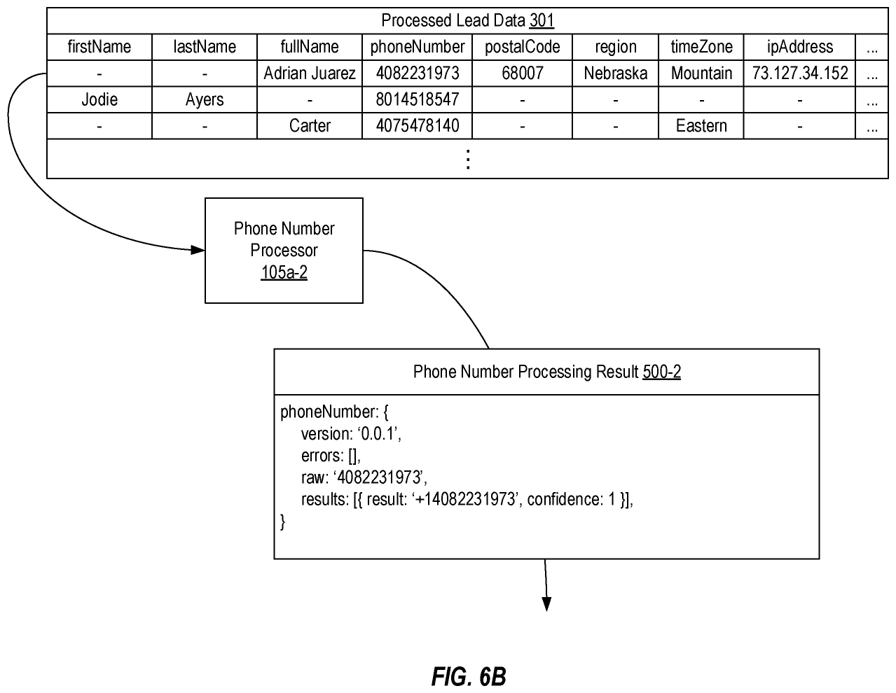

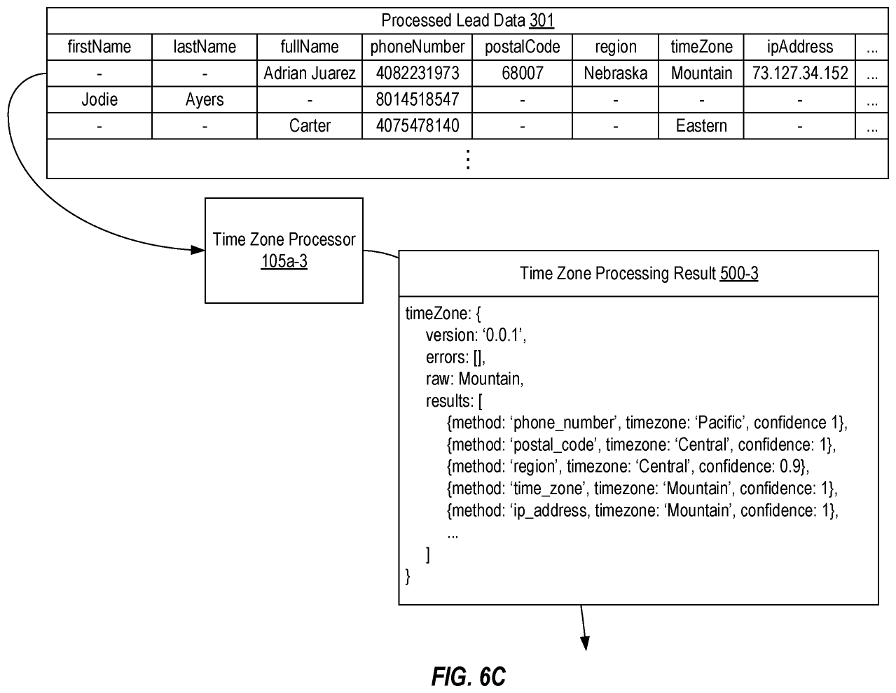

FIGS. 6A-6C each provide an example of how a field processor 105a can generate a field processing result 500 for the first row in standardized lead data 301. In FIG. 6A, name processor 105a-1 is shown as generating name processing result 500-1 which defines the predicted name (which is in the form of “givenNames” and “surnames”) from the raw data “Adrian Juarez” and a confidence value of 0.69. Name processor 105a-1 may employ a variety of techniques and may consider a variety of fields in standardized lead data 301 to generate the predicted name. For example, name processor 105a-1 may consider the values of the firstName, lastName and fullName fields and may apply a weighted algorithm, use various databases, employ artificial intelligence, etc. to predict what the givenNames and surnames should be. In the depicted example, processed lead data 301 provides “Adrian Juarez” as the raw data for the fullName field and does not provide any raw data for the firstName and lastName fields. In such a case, name processor 105a-1 could access a database of known given names and surnames to generate a prediction that Adrian is the lead's given name and Juarez is the lead's surname.

Name processor 105a-1 may generate the confidence value based on a variety of criteria. As an example, when the predicted name is generated only from a value in the fullName field, name processor 105a-1 may generate a lower confidence value than it otherwise would if the predicted name were generated from values in the firstName and lastName fields. As another example, name processor 105a-1 may generate a confidence value based on a prevalence of a name as a given name and as a surname. For example, the third row in standardized lead data 301 include only “Carter” in the fullName field. In such a case, name processor 105a-1 may use prevalence data to determine whether Carter should be assigned to the givenNames field or the surnames field in the predicted result and to calculate the confidence value. In comparison, the second row in standardized lead data 301 provides values for the firstName and lastName fields. In such a case, name processor 105a-1 may assign Jodie to the givenNames field and Ayers to the surnames field and may generate a confidence value of 1.

In some embodiments, name processor 105a-1 may be configured to restore a name as part of generating name processing result 500-1. For example, if the raw data includes an error or omission in a name, name processor 105a-1 may use a sequence-to-sequence model for predicting the correct name. In such cases, the sequence-to-sequence model can be trained using data that has been labeled with the appropriate restoration to be made.

Turning to FIG. 6B, phone number processor 105a-2 is shown as generating a phone number processing result 500-2 for the first row of standardized lead data 301. In this example, it is assumed that phone number processor 105a-2 generated a predicted phone number of +14082231973 from the raw phone number of 4082231973 with a confidence value of 1. Such may be the case when the phoneNumber field in standardized lead data 301 includes a locally complete and validly formatted phone number. In some embodiments, phone number processor 105a-2 may consider only the value of the phoneNumber field in generating a confidence value (e.g., by confirming that the phone number includes the correct number of digits, by confirming that the 3-digit exchange code is valid for the area code, etc.). In some embodiments, phone number processor 105a-2 may consider values of other fields in generating the predicted phone number and/or the confidence values. For example, if the value of the phoneNumber field does not include a country code, phone number processor 105a-2 may consider the value of the postalCode, region, timeZone, ipAddress or another field from which a location may be inferred to determine the proper country code to include in the predicted phone number. In such cases, phone number processor 105a-2 may generate a confidence value based on which fields were used to determine the country code. For example, if the value of the postalCode field is a US postal code, it does not necessarily mean that the value of the phoneNumber field is a US phone number, and therefore, the confidence value could be set to represent any such ambiguity.

Turning to FIG. 6C, time zone processor 105a-3 is shown as generating a time zone processing result 500-3 for the first row of standardized lead data 301. This example represents a scenario where a field processing result includes more than one predicted result. In a typical scenario, raw lead data 300 will not include an explicit identification of a lead's time zone (e.g., the lead likely will not have provided business 160 with his or her time zone). Therefore, time zone processor 105a-3 will likely need to predict a lead's time zone through inference based on the values of one or more location-related fields in standardized lead data 301. In some embodiments, time zone processor 105a-3 may be configured to consider values of one or more of the phoneNumber field, the postalCode field, the region field, the timeZone field, the ipAddress field, a locality field, a latitude/longitude field or other location-related field that may be included in raw lead data 300. Notably, by accurately predicting a time zone for a lead, lead data processor 105 can enable consumer interaction agents 140 to interact with consumers 170 at an appropriate or accurate time. A predicted result in time zone processing result 500-3 (i.e., each element of the results array) may define the method by which the result was predicted, the predicted time zone and the confidence value of the predicted time zone.

Time zone processor 105a-3 may predict a time zone by inference based on the phone number specified in the phoneNumber field. In particular, time zone processor 105a-3 may identify the area code and determine which time zone the area code falls in. If the area code falls in a single time zone, time zone processor 105a-3 may assign a confidence value of 1. In contrast, if the area code falls in multiple time zones, time zone processor 105a-3 may generate multiple predicted time zones (e.g., the results array may include two entries for the phone number method), each of which may be assigned an equal confidence value (e.g., 0.5 for each of two predicted time zones). Time zone processor 105a-3 can employ a similar approach when predicting a time zone or time zones based on the region.

Time zone processor 105a-3 may similarly predict a time zone by inference based on the postal code specified in the postalCode field. In particular, time zone processor 105a-3 may identify the postal code and determine which time zone the postal code falls in and assign a confidence value of 1. Time zone processor 105a-3 may likewise predict a time zone by inference based on the time zone specified in the timeZone field and may assigned a confidence value of 1.

Time zone processor 105a-3 may predict a time zone by inference based on the IP address specified in the ipAddress field. For example, time zone processor 105a-3 may be configured to determine a location from the IP address and then use that location's time zone as the predicted time zone.

Time zone processor 105a-3 may be configured to use any or all of such methods to generate a predicted time zone. In some embodiments, business 160 may specify which methods time zone processor 105a-3 should use on its raw lead data 300. In some embodiments, lead data processor 105 may use artificial intelligence to select which methods time processor 105a-3 should use for any particular raw lead data 300.

Similar techniques could be employed by other field processors 105 to generate field processing results 500 that include one or more predicted results and associated confidence values. Accordingly, a lead processing result object 510 can correspond to a particular lead/consumer and can include one or more predicted results for each of a number of fields and an associated confidence value for each predicted result.

Once lead processing result objects 510 are generated, they may be used within lead management system 100 to enhance the effectiveness and efficiency of the AI-driven interactions that consumer interaction agents 140 may have with the respective consumers 170. In some embodiments, the confidence values associated with the predicted results may be used to determine when and how to interact with consumers 170.

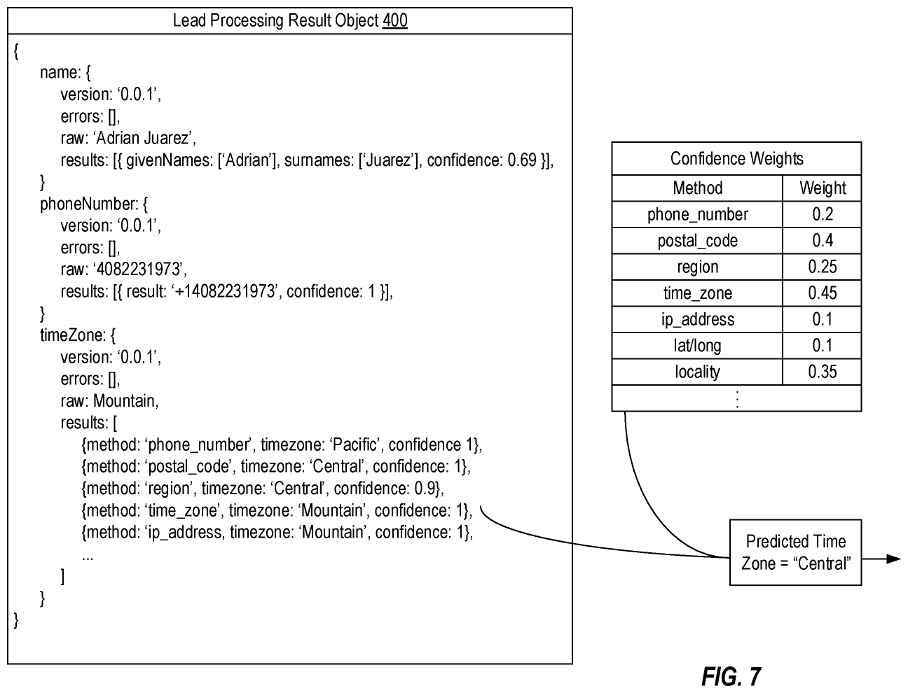

FIG. 7 provides an example of how confidence values can be used to determine when to attempt to interact with a consumer 170. FIG. 7 includes a lead processing result object 400 which is the combination of the field processing results 500 shown in FIGS. 6A-6C. FIG. 7 also includes confidence weights that can be used to predict a single time zone from the multiple predicted time zones included in lead processing result object 400. Although FIG. 7 represents that the depicted functionality is performed after lead processing result object 400 has been created, it is also possible for time zone processor 105a-3 to perform the depicted functionality as part of creating time zone processing result 500-3. However, by maintaining the multiple predicted time zones in lead processing result object 400, lead management system 100 may be able to leverage the multiple predicted time zones at any time.

In some embodiments, confidence weights may be default values that apply to all sets of raw lead data 300. In other embodiments, confidence weights may be specific to a business 160. For example, a business 160 could provide confidence weights for use with its raw lead data 300 based on its understanding of the accuracy/reliability of the various fields in raw lead data 300. As another example, lead data processor 105 may use artificial intelligence to refine the confidence weights for one business 160's raw lead data 300 based on consumer interactions that occur using lead processing result objects 400 generated from the business 160's raw lead data 300.

Confidence weights may be leveraged to enhance the accuracy of selecting a specific time zone for a lead. For example, some area codes encompass multiple time zones and, with mobile phones, the area code is not a highly reliable way to predict a lead's time zone. Accordingly, a lower confidence value may oftentimes be assigned to a time zone that is predicted using the phone number method. A postal code, region or locale typically represents a lead's home address and may therefore be a reliable way to predict a lead's time zone. Accordingly, a higher confidence value may be assigned to a time zone that is predicted using the postal code, region or locality methods. When a time zone is specified in raw lead data 300, it may be the most reliable way to predict the lead's time zone. However, many businesses 160 may infer the time zone from other information (e.g., from an IP address obtained when communicating with the lead), and in such cases, the specified time zone may be less reliable. In any case, a higher confidence value may oftentimes be assigned to a time zone predicted using the time zone method. IP addresses, latitude/longitude and other temporary information may only represent the location of the lead when the lead provided his or her information to business 160. Therefore, a lower confidence value may oftentimes be assigned to a time zone predicted using the ip address or lat/long methods. These are merely examples intended to illustrate the ambiguities involved in predicting a time zone from raw lead data 300.

In some embodiments, to predict a single time zone for a lead, the confidence weights can be applied to the confidence values and then the weighted confidence values for each time zone can be summed. The time zone having the largest sum can then be selected as the predicted time zone for the lead. In the depicted example, the weighted confidence values would be 0.2 (phone number), 0.4 (postal code), 0.225 (region), 0.45 (time zone) and 0.1 (ip address). Summing these weighted values for the predicted time zones yields 0.2 for Pacific, 0.625 for Central and 0.55 for Mountain. Accordingly, the Central time zone could be selected as the predicted time zone for Adrian Juarez. Notably, this example represents a scenario where the lead has a California phone number, a Nebraska home address/region and interacted with business 160 while in Utah (assuming that the IP address is a Utah-based IP address and that business 160 inferred the time zone from the IP address). By generating field results 500 in accordance with generic processing result 320 and by using confidence weights, lead management system 100 may make such predictions, and refine its ability to make such predictions, with high accuracy.

In some embodiments, confidence weights may be used to predict other fields. For example, in some cases, name processor 105a-1 may generate multiple predicted names, or arrangement of names, such as when there may be ambiguity or conflict in the values provided for the firstName, lastName and fullName fields (e.g., inconsistent spellings). In such cases, the confidence weights could be used to predict the mostly likely name(s) such as a particular spelling that may have been predicted based on a location-based field.

As another example, phone number processor 105a-2 may generate multiple predicted phone numbers such as when there may be multiple viable country codes. In such cases, the confidence weights could be used to predict the most likely phone number such as one that includes a country code that may have been predicted based on a location-based field.

As stated above, embodiments of the present invention can be implemented to enhance the effectiveness, efficiency, accuracy, etc. of AI-driven interactions with the respective consumers. For example, by accurately predicting the consumers' time zones, consumer interaction agents 140 can send text messages to the consumers at times when they are most likely to respond (e.g., to avoid texting too early in the morning, too late at night, during work hours, etc.). Similarly, by accurately predicting the consumers' time zones, consumer interaction agents 140 can propose times when the consumers are most likely to agree to receive a phone call and can initiate such phone calls at the accurate times.

Also, by accurately predicting the consumers' other information, consumer interaction agents 140 can more accurately and effectively tailor the content of their interactions to the consumers. As one example only, an AI-driven interaction is more likely to be effective if it includes the proper name and spelling of the consumer.

In summary, lead data processor 105 can employ a unique set of data structures, logic and functionality to efficiently extract and accurately predict information for consumers in spite of rampant ambiguities that typically exists in the raw lead data that businesses provide. As a result, a lead management system can more effectively rely on artificial intelligence to convert raw lead data into appointments between businesses and consumers.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media are categorized into two disj oint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similar storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

1. A method for processing raw lead data to enable AI-driven interactions with consumers, the method comprising:
receiving raw lead data that represents a plurality of leads;
for each of the plurality of leads represented in the raw lead data, generating a lead processing result object, each lead processing result object defining a plurality of fields, one or more predicted results for each of the plurality of fields and a confidence value for each predicted result, wherein at least some of the lead processing result objects define a time zone field, a plurality of preicted results for the time zone field and a confidence value for each of the plurality of predicted results for the time zone field, wherein the plurality of predicted results for the time zone field are generated using different methods:
selecting a particular time zone for a particular lead using the plurality of predicted results lor the time zone field defined in the lead processing result object generated for the particular lead; and
causing a consumer interaction agent to interact with the particular lead at a particular time based on the particular time zone selected for the particular lead.

2-3. (canceled)

4. The method of claim wherein the different methods employ values of different fields of the raw lead data.

5. (canceled)

6. The method of claim wherein selecting the particular time zone for the particular lead using the plurality of predicted results for the time zone field defined in the lead processing result object generated for the particular lead comprises:
applying confidence weights to the confidence values for the plurality of predicted results for the time zone field to thereby generated weighted confidence values.

7. The method of claim 6, wherein selecting the particular time zone for the particular lead using the plurality of predicted results for the time zone field defined in the lead processing result object generated for the particular lead further comprises:
for each time zone identified in the predicted results for the time zone field, summing the weighted confidence values associated with the time zone.

8. The method of claim 7, wherein selecting the particular time zone for the particular lead using the plurality of predicted results for the time zone field defined in the lead processing result object generated for the particular lead further comprises:
selecting the time zone with the highest sum of the weighted confidence values.

9. The method of claim 1, further comprising:
converting the raw lead data into standardized lead data before generating the leads processing result object for each of the plurality of lead represented in the raw lead data.

10. The method of claim 1, further comprising:
generating a plurality of field processing results for each of the plurality of leads represented in the raw lead data;
wherein generating the lead processing result object for each of the plurality of leads represented in the raw lead data comprises combining the respective plurality of field processing results.

11. The method of claim 10, wherein the plurality of field processing results include a name processing result, a phone number processing result and a time zone processing result.

12. (canceled)

13. The method of claim 1, further comprising:
using the lead processing result object generated for the particular lead to determine content that the consumer interaction agent includes in one or more interactions with the particular lead.

14. The method of claim 1, wherein the plurality of fields includes a name field and wherein the confidence value for a predicted result for the name field is generated based on values in more than one field defined in the raw lead data.

15. The method of claim 1, wherein the plurality of fields includes a phone number field and wherein the confidence value for a predicted result for the phone number field is generated based on values in more than one field defined in the raw lead data.

16. The method of claim 1, wherein the confidence value for at least one unpredicted result for the time zone field is generated based on values in more than one field defined in the raw lead data.

17. One or more computer storage media storing computer executable instructions which when executed implement a method for processing raw lead data to enable AI-driven interactions with consumers, the method comprising:
receiving raw lead data that represents a plurality of leads;
for each of the plurality of leads represented in the raw lead data, generating a lead processing result object, each lead processing result object defining:
a name field, a predicted result for the name field and a confidence value for the predicted result for the name field;
a phone number field, a predicted result for the phone number field and a confidence value for the predicted result for the phone number field; and
a time zone field, one or more predicted results for the time zone field and a confidence value for each of the one or more predicted results for the time zone field;
wherein a particular lead processing result object for a particular lead includes a plurality of predicted resuhs for the time zone field:
selecting a particular time zone for the particular lead using the plurality of predicted results for the time zone field defined in the particular lead processing result object; and
causing a consumer interaction aaent to interact with the particular lead at a particular time based on the particular time zone selected for the particular lead.

18. The computer storage media of claim 17, wherein the particu ar lead processing result object defines a method by which each of the plurality of predicted results was predicted.

19. The computer storage media of claim 18, wherein the method by which each of the plurality of predicted results was predicted identifies a field of the raw lead data.

20. A lead management system comprising:
one or more processors; and
computer storage media storing a lead data processor that is configured to process raw lead data to enable the lead management system to have AI-driven interactions with consumers, the lead data processor being configured to:
receiving raw lead data that represents a plurality of leads; and
for each of the plurality of leads represented in the raw lead data, generating a lead processing result object, each lead processing result object defining a plurality of fields, one or more predicted results for each of the plurality of fields and a confidence value for each predicted result, wherein at least some of the lead processing resuit objects define a time itooe field, a plurality of predicted results for the timezone field and a confidence value for each of the plurality of predicted results for the time zone field, wherein the plurality of predicted results for the time rone field are generated using different methods:
selecting a particular tmie zone tor a muiumlai toad esma the plurality os mcdiclccs results tor the time zone field defined in the lead processing result object generated for the particular lead: and
causing a consumer interaction agent to interact with the particular lead at a particular time based on the particular time zone selected for the particular iead.

21. The lead management system of claim 20, wherein the different methods employ values of different fields of the raw lead data.

22. The lead management system of claim 20, wherein selecting the particular time zone for the particular lead using the plurality of predicted results for the time zone field defined in the lead processing result object generated for the particular lead comprises:
applying confidence weights to the confidence values for the plurality of predicted results for the time zone field to thereby generate weighted confidence values.

23. The lead management system of claim 22, wherein selecting the particular time zone for the particular lead using the plurality of predicted results for the time zone field defined in the lead processing result object generated for the particular lead further comprises:
for each time zone identified in the predicted results for the time zone field, summing the weighted confidence values associated with the time zone.

24. The lead management system of claim 23, wherein selecting the particular time zone for the particular lead using the plurality of predicted results for the time zone field defined in the lead processing result object generated for the particular lead further comprises:
selecting the time zone with the highest sum of the weighted confidence values.
